(19) United States
(12) Patent Application Publication
(10) Pub. No.: US 2007/0067814 A1
(43) Pub. Date: Mar. 22, 2007

(54) Hotel managing system and managing method thereof

(75) Inventor: Tien-Cheng Wu, Taipei (TW)

Correspondence Address: BACON & THOMAS, PLLC, 625 SLATERS LANE, FOURTH FLOOR, ALEXANDRIA, VA, 22314, US

(73) Assignee: Aquila Multimedia CO., LTD., Taipei (TW)

(21) Appl. No.: 11/208,622

(22) Filed: Aug. 23, 2005

(51) Int. Cl. H04N 7/173

(52) U.S. Cl. 725/98

(57) ABSTRACT

A hotel managing system and a managing method thereof are disclosed. The managing system is applied for plural remote stations connected with each other via a network. The method includes steps of (a) issuing a request from one of the remote stations for initiating a transaction;(b) producing a packet consisted of one or more messages each having a general control information, a guest status information, a PAY-TV information, a guest messaging information, a guest folio information or a housekeeping information (c)transmitting the packet from the remote station to other remote station; (d)receiving the packet by the other remote station and issuing a related response; (e)transmitting the related response from the other remote station back to the remote station; and (f)completing the transaction, thereby providing several functions.

### FIELD OF THE INVENTION

This invention relates to a hotel managing system and a managing method thereof, and more particularly to a hotel managing system of plural remote stations connected with each other via a network and a managing method thereof.

### BACKGROUND OF THE INVENTION

Recently, the quality of life is keep improving, and traveling has become an essential entertainment. For striving to be in possession of the traveling market, all proprietors of the hotels are struggling with each other to develop themselves business and the traveling market has been in a turmoil. Therefore, the proprietors of the hotels have to select appropriate and convenient managing system, which is capable of strengthening themselves competitive ability without increasing managing process or complicating the managing system.

However, there are several application packages for providing service of managing hotels, and the proprietors of the hotels should make more efforts to evaluate those application packages. In practice, there is no application software able to integrate all functions related to hotel managing. Generally speaking, a simple managing system of a hotel includes a single computer for the register of customers according to the prior art. Meanwhile all managing process should be executed by artificial hands and introduce a lot of human resources. Therefore, it is not convenient to execute the managing process, and the managing system merely integrates some limited functions. Furthermore, the carelessness of labor power might cause other mistakes and fault. According to the prior art, there is another hotel managing system including a computer host and a telephone network, wherein the hotel managing system is connected with the computer host via the telephone network. Thus, the simple managing system providing several services of accumulating the charge of the customer, recoding the account, an alarm of waking up, indicating light of left messages, indicating status of housekeeping, an urgent call and so on. However, those basic functions could not fit to practical requirements. Similarly, a managing system of the prior art includes a computer host and a network of TV media management for providing basic functions. This kind of system is limited by the whole framework thereof, the data format, and the transmitting method, and merely provides the above basic functions. Meanwhile, a tenant of the guest room makes use of those functions via dull and listed characters for achieving the goal of transmitting information. The managing system is monotonous and limited in several basic functions.

Therefore, it needs to provide a hotel managing system and the hotel managing method, which introduce a graphical user interface with plural icons for facilitating the managing system to be operated via a remote control panel, introduce specific formats for facilitating to integrating transmitting data, and are capable of providing the extra managing functions without increasing managing process or complicating the managing system, and can rectify those drawbacks of the prior art and solve the above problems.

### SUMMARY OF THE INVENTION

It is an object of the present invention to provide a managing method applied in the hotel, wherein a graphical user interface with plural icons is introduced for facilitating the managing system to be operated via a remote control panel, specific formats are introduced for facilitating to integrating transmitting data, and then the extra managing functions are provided without increasing managing process or complicating the managing system, and it can rectify those drawbacks of the prior art and solve the above problems.

In accordance with an aspect of the present invention, the managing method of a host and at least a remote station connected with each other via a network, comprising steps of (a) issuing a request from one of the host and the remote station for initiating a transaction; (b) producing a packet having a field for transaction identification and consisted of a message set selected from a group of a general control information, a guest status information, a PAY-TV information, a guest messaging information, a guest folio information, a housekeeping information and a mix thereof; (c) transmitting the packet from the one of host and the remote station to another one of the host and the remote station; (d) receiving the packet by the another one of the host and the remote station and issuing a related response; (e) transmitting the related response from the another one of the host and the remote station back to the one of the host and the remote station; and (f)completing the transaction.

Preferably, the packet includes a 8-bits ASCII (American Standard Code for Information Interchange) character.

Certainly, the step (c) can be an asynchronous transmitting at a speed of 9600 bits per second.

Preferably, the packet includes a start character (ASCII 02), a text character, an End-of-Text (ETX) character (ASCII 03), and a logical redundancy check (LRC) character.

Certainly, the related response can be a single ASCII character.

Preferably, the related response is an ASCII character consisted of a acknowledge (ACK) character (ASCII 08) and a negative acknowledge (NAK) character (ASCII 15) for indicating success in the transaction while the first station receives the ACK character by 2 second after the packet has been transmitted, and indicating failure in the transaction while the first station receives the NAK character or free of the related response by 2 second after the packet has been transmitted.

Preferably, the one of the host and the remote station transmits the packet via a transaction layer in at most 3 times for achieving the transaction of the packet, and the transaction layer receives an error message to terminate and achieve the transaction of the packet while the one of the host and the remote station receives 3 NAK character or free of the related response.

Preferably, the host further includes a property management system (PMS) and the remote station includes an aquila advanced television system (AATS).

Preferably, the transaction includes a unique 4-byte transaction identifier respectively in a form of “Sxxx” for PMS and “Hxxx” for AATS to identify the transaction, wherein “x” is a numeral ASCII character.

Preferably, the packet includes several messages having an identical transaction identifier.

Preferably, the message set of the packet comprises a transaction identifier, a serial number, an instruction, and a related information of the instruction, wherein the serial number is a 4-bits field.

It is another object of the present invention to provide a managing system applied in the hotel, wherein a graphical user interface with plural icons is introduced for facilitating the managing system to be operated via a remote control panel, specific formats are introduced for facilitating to integrating transmitting data, and then the extra managing functions are provided without increasing managing process or complicating the managing system, and it can rectify those drawbacks of the prior art and solve the above problems.

In accordance with an aspect of the present invention, the managing system includes plural stations; a network connected with the plural stations; and a packet transmitted among the plural stations via the network, having a field for transaction identification and consisted of a message set selected from a group of a general control information, a guest status information, a PAY-TV information, a guest messaging information, a guest folio information, a housekeeping information and a mix thereof.

Preferably, each one of the plural stations further includes a RS-232 serial port for connecting with each other via the network.

Preferably, and the plural stations includes a host and a remote station.

Preferably, the host has a property management system (PMS) and the remote station has an aquila advanced television system (AATS).

Preferably, the packet includes a start character (ASCII 02), a text character, an End-of-Text (ETX) character (ASCII 03), and a logical redundancy check (LRC) character.

Preferably, the message set of the packet comprises a transaction identifier, a serial number, an instruction, and a related information of the instruction.

Preferably, the packet includes several messages having an identical transaction identifier.

Certainly, the serial number can be a 4-bits field.

In accordance with an aspect of the present invention, the managing method of plural remote stations connected with each other via a network, comprising steps of (a) issuing a request from a first of the plural remote stations for initiating a transaction; (b) producing a packet having a field for transaction identification and consisted of a message set selected from a group of a general control information, a guest status information, a PAY-TV information, a guest messaging information, a guest folio information, a housekeeping information and a mix thereof; (c) transmitting the packet from the first station to a second one of the plural remote stations; (d) receiving the packet by the second one of the remote station and issuing a related response; (e) transmitting the related response from the second one of the remote stations back to the first one of the plural remote stations; and (f)completing the transaction.

Preferably, the packet includes a 8-bits ASCII (American Standard Code for Information Interchange) character.

Certainly, the step (c) can be an asynchronous transmitting at a speed of 9600 bits per second.

Preferably, the packet includes a start character (ASCII 02), a text character, an End-of-Text (ETX) character (ASCII 03), and a logical redundancy check (LRC) character.

Certainly, the related response can be a single ASCII character.

Preferably, the related response is an ASCII character consisted of a acknowledge (ACK) character (ASCII 08) and a negative acknowledge (NAK) character (ASCII 15) for indicating success in the transaction while the first station receives the ACK character by 2 second after the packet has been transmitted, and indicating failure in the transaction while the first station receives the NAK character or free of the related response by 2 second after the packet has been transmitted.

Preferably, the first station transmits the packet via a transaction layer in at most 3 times for achieving the transaction of the packet, and the transaction layer receives an error message to terminate and achieve the transaction of the packet while the first station receives 3 NAK character or free of the related response.

Preferably, the plural station includes a host having a property management system (PMS) and at least a remote station having an aquila advanced television system (AATS).

Preferably, the transaction includes a unique 4-byte transaction identifier respectively in a form of “Sxxx” for PMS and “Hxxx” for AATS to identify the transaction, wherein “x” is a numeral ASCII character.

Certainly, the general control information can be composed of an initialization information of the plural stations, a coordinating information of database, a connecting information, a transmitting identification information and an error reporting information for controlling messages of a communication link.

Certainly, the guest status information can be composed of a check-in information, a check-out information, and a customer information update transmitted via the PMS and the ATTS.

Certainly, the PAY-TV information can be composed of a charge-update information transmitted from the AATS to the PMS.

Certainly, the guest messaging information can be composed of a receiver and caller information, an illustration information of a message, and a content information of a message.

Certainly, the housekeeping information can be composed of the latest housekeeping information transmitted from the ATTS to the PMS.

Preferably, the step (a) of issuing the request from the first station is executed via an input device of the host while the first station is the host, and via plural icons of a graphical user interface in the remote station while the first station is the remote station, wherein a remote control panel operates the plural icons.

Preferably, the message set of the packet comprises a transaction identifier, a serial number, an instruction, and a related information of the instruction.

Preferably, the packet includes several messages having an identical transaction identifier.

Certainly, the serial number can be a 4-bits field.

Preferably, the serial number is increased gradually in the transaction.

Preferably, the packet has an initialized serial number “0000” and an end serial number “9999”.

Preferably, the request and the related response have an identical transaction identifier.

In accordance with another aspect of the present invention, the managing system includes a host, plural remote stations; a network connected with the host and the plural stations; and a packet transmitted among the plural stations via the network, having a field for transaction identification and consisted of a message set selected from a group of a general control information, a guest status information, a PAY-TV information, a guest messaging information, a guest folio information, a housekeeping information and a mix thereof.

Preferably, each one of the host and the plural stations includes a RS-232 serial port for connecting with each other via the network.

Preferably, the host has a property management system (PMS) and the remote station has an aquila advanced television system (AATS).

Preferably, the packet includes a start character (ASCII 02), a text character, an End-of-Text (ETX) character (ASCII 03), and a logical redundancy check (LRC) character.

Preferably, the message set of the packet comprises a transaction identifier, a serial number, an instruction, and a related information of the instruction.

Preferably, the packet includes several messages having an identical transaction identifier.

Certainly, the serial number can be a 4-bits field.

Preferably, the serial number is increased gradually in the transaction.

Preferably, the packet has an initialized serial number “0000” and an end serial number “9999”.

Preferably, each one of the plural remote stations further includes a graphical user interface for providing a communicating interface.

Preferably, the graphical user interface has plural icons for facilitating the managing system to be operated via a remote control panel.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates an embodiment of the hotel managing system according to the present invention;

FIG. 2 illustrates the data format of a packet according to the present invention;

FIG. 3 illustrates the data format of a message information according to the present invention; and

FIG. 4 illustrates a flow chart of an embodiment of the hotel managing method according to the present invention.

### DETAILED DESCRIPTION OF THE PREFERRED EMBODIMENT

The present invention discloses a hotel managing system and a method thereof, and the objects and advantages of the present invention will become more readily apparent to those ordinarily skilled in the art after reviewing the following detailed description. The present invention needs not be limited to the following embodiment.

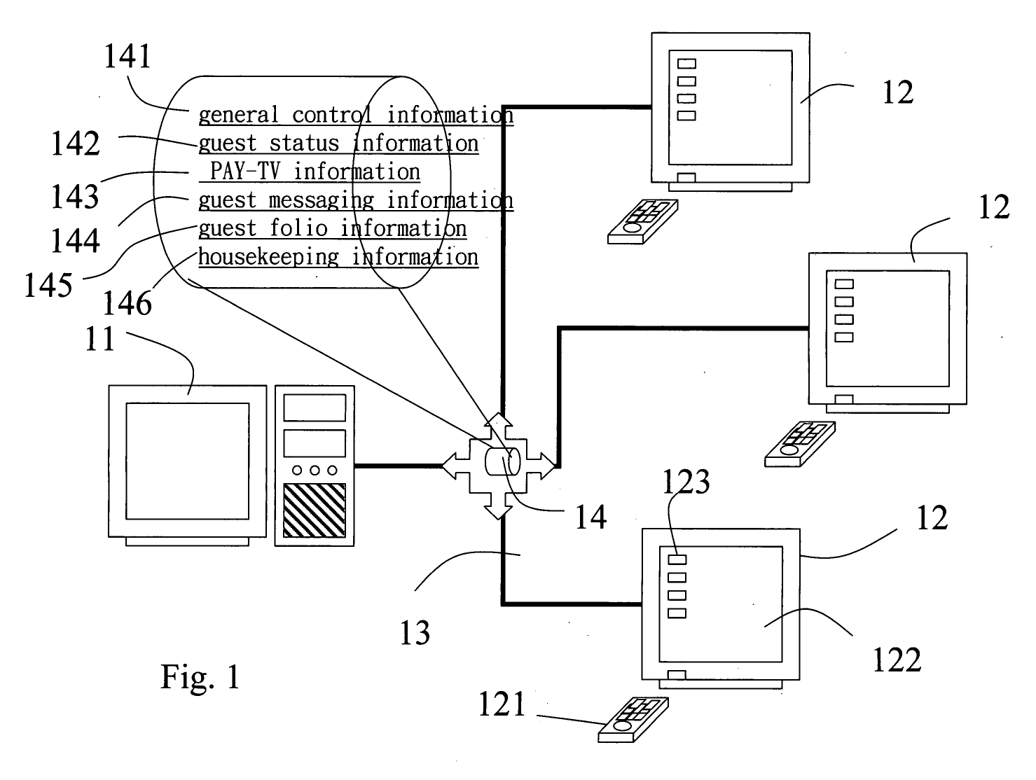

Please refer to FIG. 1. It illustrates an embodiment of the hotel managing system according to the present invention. The managing system includes a host 11, at least a remote station 12; a network 13 connected with the host 11 and the remote station 12; and a packet 14 transmitted among the plural stations via the network 13, having a field for transaction identification and consisted of a message set selected from a group of a general control information 141, a guest status information 142, a PAY-TV information 143, a guest messaging information 144, a guest folio information 145, a housekeeping information 146 or a mix thereof, wherein the host 11 and the remote station 12 both include RS-232 serial ports for connecting with each other via the network 13. In practice, the host 11 is a host of property management system (PMS), and it could be a computer server providing application software for the managing system and setting up the database for the managing system. On the other hand, the remote station 12 can be a station of aquila advanced television system (AATS). That station 12 is a digital multimedia TV station, which is disposed in each guest room and the user of the guest room could initialize a transaction via a remote control panel 121.

In accordance with the aspect of the present invention, the packet 14 could include a general control information 141, a guest status information 142, a PAY-TV information 143, a guest messaging information 144, a guest folio information 145, or a housekeeping information 146. Actually, the packet 14 has a date format including a start character (ASCII 02) 1471, a text via a remote control panel 121 could operate the graphical user interface 122 for selecting the required service thereby sending a required packet. In practice, the graphical user interface 122 further includes plural icons 123 disposed around the peripheral thereof for facilitating the managing system to be operated via the remote control panel 121. The user of the guest room could select the required service via the remote control panel 121 directly.

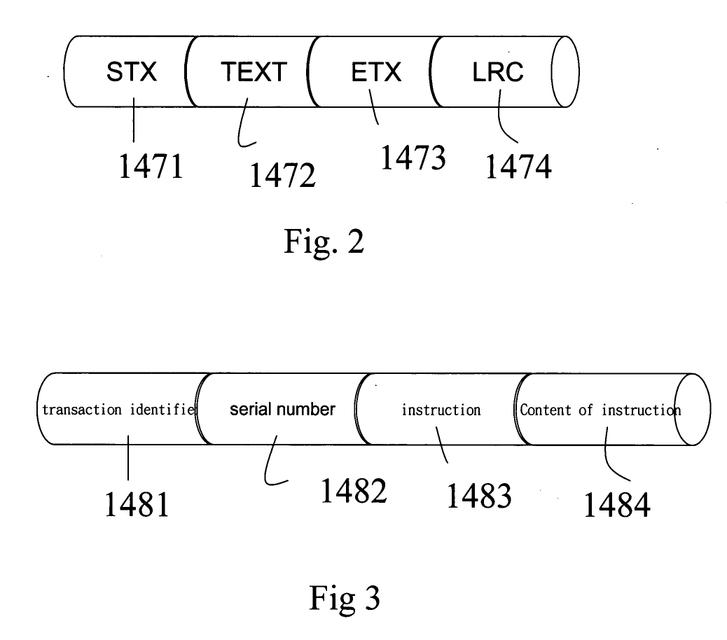

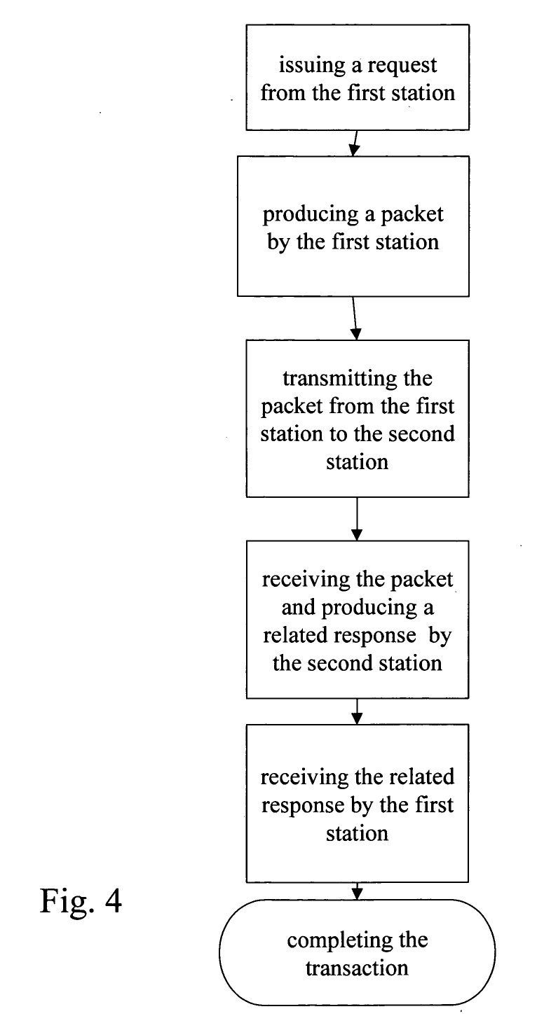

Please refer to FIG. 4. It illustrates a flow chart of an embodiment of the hotel managing method according to the present invention. The managing method, applied among a host 11 and plural remote stations 12 connected with each other via a network 13 (as shown in FIG. 1), includes at least steps of (a) issuing a request from the host 11 (or the remote station 12) for initiating a transaction, wherein the request issue is produced via an input device of the host 11 while the request is issued from the host (or via plural icons 123 of a graphical user interface 122 in the remote station 12 while the request is issued from the remote station 12, wherein the plural icons 123 are operated by a remote control panel 121); (b) producing a packet 14 having a field for transaction identification and consisted of a message set selected from a group of a general control information 141, a guest status information 142, a PAY-TV information 143, a guest messaging information 144, a guest folio information 145, a housekeeping information 146 and a mix thereof; (c) transmitting the packet 14 from the host 11 (or the remote station 12) to the remote station 12 (or the host 11 and other remote stations 12); (d) receiving the packet 14 by the remote station 12 (or the host 11 and other remote stations 12) and issuing a related response; (e) transmitting the related response from the remote station 12 (or the host 11 and other remote stations 12) back to the host 11 (or the remote station 12); and (f)completing the transaction. character 1472, an End-of-Text (ETX) character (ASCII 03) 1473, and a logical redundancy check (LRC) character 1474, as shown in FIG. 2; it illustrates the data format of a packet according to the present invention. According to the present invention, the packet 14 is a message set composed by one or more message information selected from the group of the general control information 141, the guest status information 142, the PAY-TV information 143, the guest messaging information 144, the guest folio information 145, and the housekeeping information 146. Meanwhile each message information of the message set 14 includes a transaction identifier 1481, a serial number 1482, an instruction 1483, and a related information 1484 of the instruction 1483, as shown in FIG. 3; it illustrates the data format of a message information according to the present invention. One packet 14 includes one or more message information, and each message information in the same packet 14 has one identical transaction identifier 1481.

In the present invention, the serial number 1482 is controlled via a 4-bits field, wherein the serial number 1482 is increased gradually in the transaction, and there should be an initialized serial number “0000” and an end serial number “9999” in one packet 14. For a packet including 5 message information as a message set, there should 5 serial number 1482 in the packet, and they could be increased gradually as “0000 0001 0002 0003 9999”. In the present invention, the general control information 141, the guest status information 142, the PAY-TV information 143, the guest messaging information 144, the guest folio information 145, and the housekeeping information 146 can be transmitted among the network 13. The remote station 12 further has a graphical user interface 122 for providing a communicating interface with the user of the guest room, wherein the user of the guest room

In practice, the packet is form by a 8-bits ASCII (American Standard Code for Information Interchange) character. The step (c) is executed by means of an asynchronous transmitting at a speed of 9600 bits per second. Moreover, the packet 14 has a date format including a start character (ASCII 02) 1471, a text character 1472, an End-of-Text (ETX) character (ASCII 03) 1473, and a logical redundancy check (LRC) character 1474. In the embodiment, the related response can be formed by a single ASCII character and the single ASCII is one of a acknowledge (ACK) character (ASCII 08) and a negative acknowledge (NAK) character (ASCII 15), wherein the ACK character and the NAK character are introduced respectively for indicating success in the transaction while the first station receives the ACK character by 2 second after the packet has been transmitted, and indicating failure in the transaction while the first station receives the NAK character or free of the related response by 2 second after the packet has been transmitted. Actually, the first station transmits the packet 14 via a transaction layer in at most 3 times for achieving the transaction of the packet 14, and the transaction layer receives an error message to terminate and achieve the transaction of the packet while the first station receives 3 NAK character or free of the related response.

In this embodiment of the present invention, the host 11 is a host of property management system (PMS), and it could be a computer server providing application software for the managing system and setting up the database for the managing system. On the other hand, the remote station 12 can be a station of aquila advanced television system (AATS). That station 12 is a digital multimedia TV station, which is disposed in each guest room and the user of the guest room could initialize a transaction via a remote control panel 121. For one transaction, all packets of the transaction include a unique 4-byte transaction identifier respectively. The transaction of ATTS is in a form of “Sxxx” for PMS and the transaction of PMS is in a form of “Hxxx” for identifying the transaction, wherein “x” is a numeral ASCII character.

Furthermore, the packet 14 is a message set composed by one or more message information selected from the group of the general control information 141, the guest status information 142, the PAY-TV information 143, the guest messaging information 144, the guest folio information 145, and the housekeeping information 146. Those message information could be transmitted among the host 11 and the plural remote stations 12 by the managing method of the present invention.

The remote station 12 further has a graphical user interface 122 for providing a communicating interface with the user of the guest room, wherein the user of the guest room via a remote control panel 121 could operate the graphical user interface 122 for selecting the required service thereby sending and issuing a required packet. In practice, the graphical user interface 122 further includes plural icons 123 disposed around the peripheral thereof for facilitating the managing system to be operated via the remote control panel 121. The user of the guest room could select the required service via the remote control panel 121 directly. In practice, the general control information 141 can be composed of an initialization information of the plural stations, a coordinating information of database, a connecting information, a transmitting identification information and an error reporting information for controlling messages of a communication link; the guest status information 142 can be composed of a check-in information, a check-out information, and a customer information update transmitted via the PMS and the ATTS; the PAY-TV information 143 can be composed of a charge-update information transmitted from the AATS to the PMS; the guest messaging information 144 can be composed of a receiver and caller information, an illustration information of a message, and a content information of a message; the guest folio information 145 can be a customer's file; and the housekeeping information 146 can be composed of the latest housekeeping information transmitted from the ATTS to the PMS. After introducing those specific data formats, the managing method of the present invention could provide and integrate several extra managing functions to fit in with the practical requirement.

In conclusion, the present invention provides a hotel managing system and a managing method, which could be applied between property management system (PMS) and aquila advanced television system (AATS), wherein a graphical user interface with plural icons is introduced for facilitating the managing system to be operated via a remote control panel, specific formats are introduced for facilitating to integrating transmitting data, and the system integrates several extra managing functions without increasing managing process or complicating the managing system. Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A managing method of plural stations connected with each other via a network, comprising steps of:
(a) issuing a request from a first one of the plural stations for initiating a transaction;
(b) producing a packet having a field for transaction identification and consisted of a message set selected from a group of a general control information, a guest status information, a PAY-TV information, a guest messaging information, a guest folio information, a housekeeping information and a mix thereof;
(c) transmitting the packet from the first station to a second one of the plural station;
(d) receiving the packet by the second station and issuing a related response;
(e) transmitting the related response from the second station back to the first station; and
(f) completing the transaction.

2. The managing method according to claim 1, wherein the packet comprises a 8-bits ASCII (American Standard Code for Information Interchange) character.

3. The managing method according to claim 1, wherein the step (c) is an asynchronous transmitting at a speed of 9600 bits per second.

4. The managing method according to claim 1, wherein the packet comprises a start character (ASCII 02), a text character, an End-of-Text (ETX) character (ASCII 03), and a logical redundancy check (LRC) character.

5. The managing method according to claim 1, wherein the related response is an ASCII character consisted of a acknowledge (ACK) character (ASCII 08) and a negative acknowledge (NAK) character (ASCII 15) for indicating success in the transaction while the first station receives the ACK character by 2 second after the packet has been transmitted, and indicating failure in the transaction while the first station receives the NAK character or free of the related response by 2 second after the packet has been transmitted.

6. The managing method according to claim 1, wherein the first station transmits the packet via a transaction layer in at most 3 times for achieving the transaction of the packet, and the transaction layer receives an error message to terminate and achieve the transaction of the packet while the first station receives 3 NAK character or free of the related response.

7. The managing method according to claim 1, wherein plural remote stations comprises at least a host having a property management system (PMS) and a remote station having an aquila advanced television system (AATS), and the PMS and the AATS comprise unique 4-byte transaction identifiers respectively in a form of “Sxxx” and “Hxxx” for identifying of the transaction, wherein “x” is a numeral ASCII character.

8. The managing method according to claim 7, wherein the general control information is composed of an initialization information of the plural stations, a coordinating information of database, a connecting information, a transmitting identification information and an error reporting information for controlling messages of a communication link.

9. The managing method according to claim 7, wherein the guest status information is composed of a check-in information, a check-out information, and a customer information update transmitted via the PMS and the ATTS.

10. The managing method according to claim 7, wherein the PAY-TV information is composed of a charge-update information transmitted from the AATS to the PMS.

11. The managing method according to claim 7, wherein the guest messaging information is composed of a receiver and caller information, an illustration information of a message, and a content information of a message.

12. The managing method according to claim 7, wherein the housekeeping information is composed of the latest housekeeping information transmitted from the ATTS to the PMS.

13. The managing method according to claim 7, wherein the step (a) of issuing the request from the first station is executed via an input device of the host while the first station is the host, and via plural icons of a graphical user interface in the remote station while the first station is the remote station, wherein the plural icons are operated by a remote control panel.

14. The managing method according to claim 1, wherein the message set of the packet comprises a transaction identifier, a serial number, an instruction, and a related information of the instruction, the serial number is a 4-bits field and increased gradually in the transaction, and the packet has an initialized serial number “0000” and an end serial number “9999”.

15. The managing method according to claim 1, wherein the request and the related response have an identical transaction identifier.

16. A managing system for a hotel comprising:
plural stations;
a network connected with the plural stations; and
a packet transmitted among the plural stations via the network, having a field for transaction identification and consisted of a message set selected from a group of a general control information, a guest status information, a PAY-TV information, a guest messaging information, a guest folio information, a housekeeping information and a mix thereof.

17. The managing system according to claim 16, wherein each one of the plural stations further comprises a RS-232 serial port for connecting with each other via the network, and the plural stations comprises a host having a property management system (PMS) and a remote station having an aquila advanced television system (AATS).

18. The managing system according to claim 17, wherein the remote station further comprises a graphical user interface with plural icons for facilitating the managing system to be operated via a remote control panel.

19. The managing system according to claim 16, wherein the packet comprises a start character (ASCII 02), a text character, an End-of-Text (ETX) character (ASCII 03), and a logical redundancy check (LRC) character.

20. The managing system according to claim 16, wherein the message set of the packet comprises a transaction identifier being identical in one packet, a serial number, an instruction, and a related information of the instruction, all messages in one packet have the same transaction identifier, and the serial number is a 4-bits field.
